(19) United States
(12) Patent Application Publication
(10) Pub. No.: US 2006/0067490 A1
(43) Pub. Date: Mar. 30, 2006

(54) Sales support system, information processor, and adviser support system

(75) Inventors: Dai Furuie, Kobe-shi (JP); Kaya Yamada, Kobe-shi (JP); Miyako Honjo, Kobe-shi (JP); Daisuke Honjo, Kobe-shi (JP); Minoru Okamoto, Kusatsu-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/239,182

(22) Filed: Sep. 29, 2005

(30) Foreign Application Priority Data
Sep. 29, 2004 (JP) 2004-282916
Jun. 10, 2005 (JP) 2005-171433

(51) Int. Cl. H04M 11/00

(52) U.S. Cl. 379/93.12; 379/114.2

(57) ABSTRACT

A sales supporting system is described, a representative one of which includes a sales support system for supporting work of a salesperson of commodities, comprising: input means for entering life information regarding life of a customer; commodity selection support information generating means for generating commodity selection support information for supporting selection by the salesperson of a commodity for health of the customer on the basis of the life information entered by using the input means; and output means for outputting the commodity selection support information generated by the commodity selection support information generating means.

This application claims priority under 35 U.S.C. § 119 to Japanese Patent Application Nos. 2004-282916 filed Sep. 29, 2004 and 2005-171433 filed Jun. 10, 2005, the entire contents of which are hereby incorporated herein by reference.

### FIELD OF THE INVENTION

The present invention relates to a sales support system, an information processor, and an adviser supporting system.

### BACKGROUND

Hitherto, a sales support apparatus (sales support system) for providing information of a commodity to be purchased by a customer is known (refer to, for example, Japanese Patent Application Laid-open (JP-A) Nos. 2003-16337 and 2004-192554).

JP-A No. 2003-16337 discloses a medical treatment assisting commodity sales supporting apparatus for providing a patient with information of a medical treatment assisting commodity such as a health food suitable for a patient on the basis of medical treatment information of the patient.

JP-A No. 2004-192554 discloses a sales support system for extracting information of a commodity suitable for a customer from a commodity information storage (storing means) on the basis of information answered by the customer and presenting the extracted commodity information and information indicative of the place of a shelf in which the commodity is put to the customer.

A healthiness measuring apparatus for determining healthiness of an subject to measurement on the basis of information obtained from the subject to measurement is also known (refer to, for example, JP-A No. 11-318830).

JP-A No. 11-318830 discloses a healthiness measurement apparatus for determining healthiness of an subject to measurement on the basis of a result of questionnaire to the subject to measurement and biological information such as blood pressure and pulse of the subject to measurement and displaying the healthiness of the object.

Each of the sales support apparatus and the sales support system disclosed in JP-A Nos. 2003-16337 and 2004-192554 is constructed so that a list of commodities to be purchased by a patient or customer can be viewed by the patient or customer.

Therefore, patients or customers do not have much medical knowledge or knowledge of commodities. There is consequently a problem that the patient or customer cannot determine the most effective commodity to be purchased from the list of commodities displayed.

On the other hand, the healthiness measuring apparatus disclosed in JP-A No. 11-318830 displays healthiness of an subject to measurement but the subject to measurement cannot grasp which action to be taken in accordance with the displayed healthiness. For example, in the case where low healthiness is measured, the subject to measurement cannot grasp which commodity is to be taken in order to improve the healthiness. As described above, the healthiness measuring apparatus disclosed in JP-A No. 11-318830 is used to simply present the healthiness to the subject to measurement. There is a problem such that the subject to measurement cannot obtain information of a commodity to be purchased in order to recover his/her health condition.

### SUMMARY

The present invention has been done to solve the problems and an object of the present invention is to provide a sales support system, an information processor, and an adviser support system helping a salesperson or an adviser to recommend a suitable commodity.

According to a first aspect of the present invention, there is provided a sales support system for supporting work of a salesperson of commodities, comprising: input means for entering life information regarding life of a customer; commodity selection support information generating means for generating commodity selection support information for supporting selection by the salesperson of a commodity for health of the customer on the basis of the life information entered by the input means; and output means for outputting the commodity selection support information generated by the commodity selection support information generating means.

According to a second aspect of the invention, there is provided an information processor connected to a first device for entering life information regarding life of a customer and a second device for outputting commodity selection support information for supporting selection by a salesperson of commodities for health of a customer, comprising commodity selection support information generating means for generating the commodity selection support information on the basis of the life information entered to the first device.

According to a third aspect of the invention, there is provided an adviser support system for supporting an adviser, comprising: input means for entering life information regarding life of a person to whom a piece of advice is to be given; commodity selection support information generating means for generating commodity selection support information for supporting selection by the adviser of a commodity for health of the person to whom a piece of advice is to be given on the basis of the life information entered by the input means; and output means for outputting the commodity selection support information generated by the commodity selection support information generating means.

### BRIEF DESCRIPTION OF THE DRAWINGS

FIG. 1 is a perspective view showing a general configuration of a sales support system according to a first embodiment.

FIG. 2 is a schematic diagram illustrating the configuration of the sales support system according to the first embodiment.

FIG. 3 is a schematic diagram illustrating the configuration of a controller of an apparatus for customer in the sales support system according to the first embodiment.

FIG. 4 is a schematic diagram illustrating the configuration of a controller of an apparatus for pharmacist in the sales support system according to the first embodiment.

FIG. 5 is a diagram showing the outline of a process flow of the apparatus for customer in the sales support system according to the first embodiment.

FIG. 6 is a diagram showing a picture in steps S2 and S42 in the apparatus for customer in the sales support systems according to the first embodiment and a second embodiments.

FIG. 7 is a diagram showing a picture in steps S3 and S43 in the apparatus for customer in the sales support systems according to the first and second embodiments.

FIG. 8 is a diagram showing a picture in steps S4 and S44 in the apparatus for customer in the sales support systems according to the first and second embodiments.

FIG. 9 is a diagram showing a picture in steps S6 and S47 in the apparatus for customer in the sales support systems according to the first and second embodiments.

FIG. 10 is a diagram showing a picture in steps S13 and S51 in the apparatus for customer in the sales support systems according to the first and second embodiments.

FIG. 11 is a diagram showing a report to be printed in step S15 of the apparatus for customer in the sales support system according to the first embodiment.

FIG. 12 is a diagram showing the outline of the process flow of the apparatus for pharmacist in the sales support system according to the first embodiment.

FIG. 13 is a diagram showing a picture in steps S28 and S72 in the apparatus for pharmacist in the sales support system according to the first and second embodiments.

FIG. 14 is a diagram showing a picture in step S29 in the apparatus for pharmacist in the sales support system according to the first embodiment.

FIG. 15 is a diagram showing a picture in step S32 in the apparatus for pharmacist in the sales support system according to the first embodiment.

FIG. 16 is a perspective view showing a general configuration of a sales support system according to the second embodiment.

FIG. 17 is a schematic diagram illustrating the configuration of the sales support system according to the second embodiment.

FIG. 18 is a schematic diagram illustrating the configuration of a controller of the apparatus for customer in the sales support system according to the second embodiment.

FIG. 19 is a schematic diagram illustrating the configuration of a controller of the apparatus for pharmacist in the sales support system according to the second embodiment.

FIG. 20 is a schematic diagram illustrating the configuration of a controller of a server in the sales support system according to the second embodiment.

FIG. 21 is a diagram showing the outline of the process flow of the apparatus for customer, a server, and an apparatus for pharmacist in the sales support system according to the second embodiment.

FIG. 22 is a diagram showing a report printed by the apparatus for customer in step S53 illustrated in FIG. 21.

FIG. 23 is a diagram showing a picture in steps S28 and S72 of the apparatus for pharmacist in a sales support system according to a modification of the first and second embodiments.

FIG. 24 is a diagram showing a picture in step S32 of the apparatus for pharmacist in a sales support system according to a modification of the first embodiment.

### DETAILED DESCRIPTION OF THE PREFERRED EMBODIMENT

Embodiments will be described below with reference to the drawings.

### First Embodiment

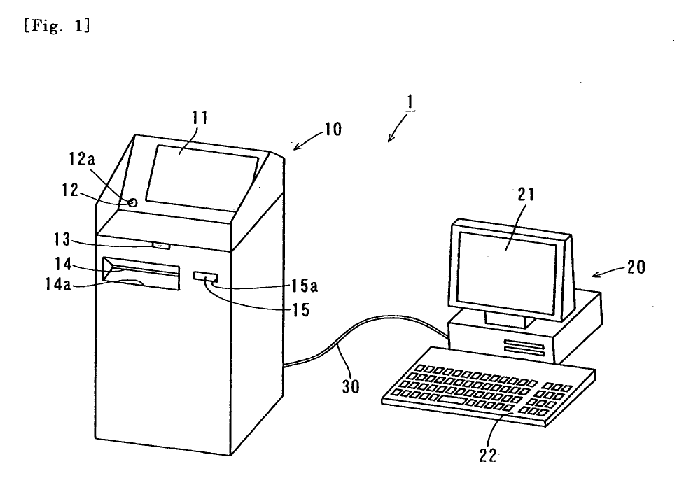

First, the configuration of a sales support system of a first embodiment will be described with reference to FIGS. 1 to 4.

In the first embodiment, as shown in FIG. 1, a sales support system 1 is a system for supporting a work of a pharmacist and has an apparatus 10 for a customer and an apparatus 20 for a pharmacist. The apparatus 10 for customer and the apparatus 20 for pharmacist are connected to each other via a LAN (Local Area Network) cable 30. The apparatus 10 for customer is an apparatus used by a customer and is disposed near the entrance of a pharmacy, near the side of a shelf in which health food is displayed, and the like. In an upper part of the front face of the apparatus 10 for customer, a touch panel display (hereinafter, called touch panel) 11 for displaying information on health food and the like to customers, and used to enter basic information such as sex, age, height, and weight, life information of a customer such as work, sleeping hours, and eating habits, and the like is provided. In a part below the left corner of the touch panel 11 of the apparatus 10 for customer, a measuring part 12 for measuring hemoglobin concentration (biological information) of a customer is provided. The measuring part 12 has an insertion part 12a to which the middle finger of the left hand of the customer is inserted. The measuring part 12 is constructed to measure hemoglobin concentration by capturing a transfer image of blood vessels without taking blood of the customer. As the method of measuring hemoglobin concentration, for example, a conventional measuring method disclosed in U.S. Pat. No. 5,722,398 is used. A human sensor 13 is disposed in a center portion of the front face of the apparatus 10 for customer. The human sensor 13 is a light reflection sensor for detecting a customer who stands in front of the apparatus 10 for customer. When the human sensor 13 detects that the customer stands in front of the apparatus 10 for customer, the touch panel 11 becomes operable. Below the human sensor 13, a printer 14 for printing information such as health conditions of the customer and components to be taken by the customer, and a report ejection port 14a are provided. On the right side of the report ejection port 14a, an ID reader 15 for reading information recorded on an ID card (not shown) recording the ID (membership number) of a customer and the history of health conditions, life information, health foods taken, and the like is provided. The ID reader 15 has an insertion port 15a into which an ID card is inserted. The ID card has the function of a credit card. In the case where a customer purchases a commodity, payment may be completed by reading the ID card by the ID reader 15.

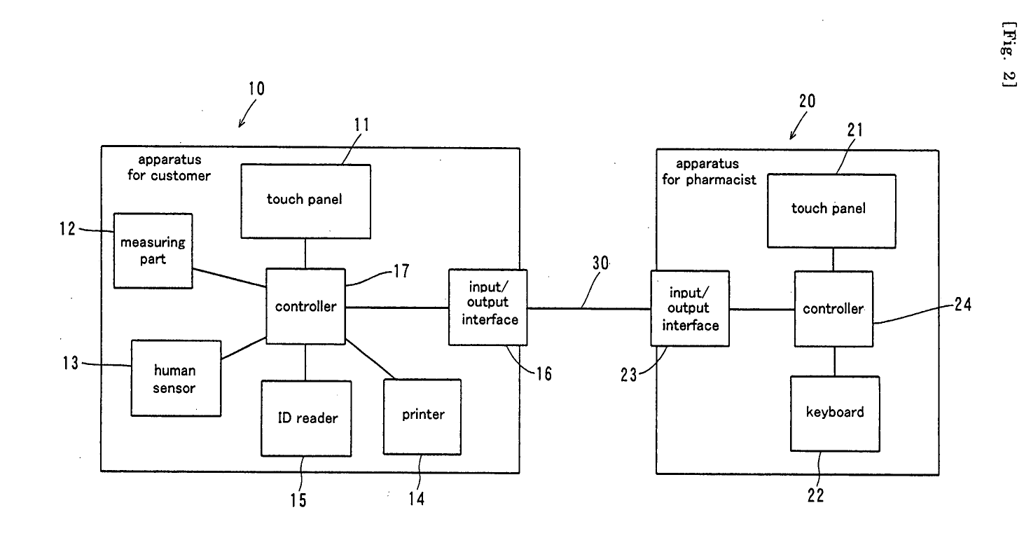

In the first embodiment, as shown in FIG. 2, the apparatus 10 for customer has there in an input/output interface 16 connected to a LAN cable 30. A controller 17 is connected to the touch panel 11, the measuring part 12, the human sensor 13, the printer 14, the ID reader 15, and the input/output interface 16.

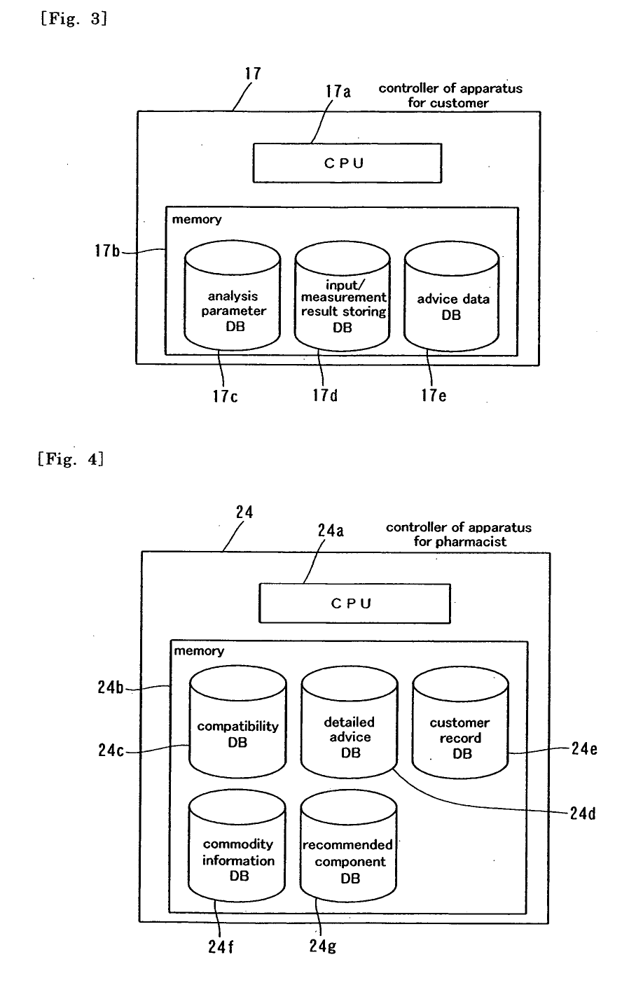

As shown in FIG. 3, the controller 17 a CPU (Central Processing Unit) 17a and a memory 17b. The memory 17b includes an analysis parameter DB (database) 17c, an input/measurement result storing DB 17d, and an advice data DB 17e. In the analysis parameter DB 17c, parameters used for analyzing health conditions of a customer on the basis of the life information and the biological information are stored. In the input/measurement result storing DB 17d, the information (basic information and life information) entered by the customer and hemoglobin concentration of the customer measured by the measuring part 12 is stored, and the history of measurement results of hemoglobin concentration are stored. In the advice data DB 17e, a plurality of pieces of advice data for the customer corresponding to the measured hemoglobin concentration and the entered life information are stored. The plurality of pieces of advice data include information for suggesting maintenance or improvement of health of a customer such as advice on nutrition to a customer, advice on exercise to a customer, advice on life rhythms to a customer, information of a component short of the customer (information of a component to be taken by the customer), and general advice.

In the first embodiment, the apparatus 20 for pharmacist (refer to FIG. 1) is an apparatus used by a pharmacist who sells medical care goods and health foods, and is disposed in an office of a pharmacy, near the side of a register, or the like so that display of a touch panel display (hereinafter, called touch panel) 21 (refer to FIG. 1) is not seen by customers. To the apparatus 20 for pharmacist, a keyboard 22 for entering the ID (membership number) or keyword of a customer is connected as shown in FIG. 1. The apparatus 20 for pharmacist may be constructed by connecting a bar code reader (not shown), and the ID of a customer is read from an ID card (not shown) by using the bar code reader. The apparatus 20 for pharmacist has therein an input/output interface 23 connected to the LAN cable 30 as shown in FIG. 2. To the touch panel 21, keyboard 22, and input/output interface 23, a controller 24 is connected.

The controller 24 includes a CPU 24a and a memory 24b as shown in FIG. 4. The memory 24b includes a compatibility DB 24c, a detailed advice DB 24d, a customer record DB 24e, a commodity information DB 24f, and a recommended component DB 24g. In the compatibility DB 24c, a plurality of pieces of information (compatibility data) regarding the chemistry between a health food the pharmacist is to recommend to a customer and the other drugs and health foods are stored. In the detailed advice DB 24d, data of a plurality of pieces of advice for a pharmacist is stored so that the pharmacist can give a piece of advice to maintain or improve health to a customer. The advice data for a pharmacist stored in the detailed advice DB 24d in the apparatus 20 for pharmacist includes information, which is more detailed than advice data for a customer, which is stored in the advice data DB 17e in the controller 17 shown in FIG. 3. In the customer record DB 24e, results and history of measurements of hemoglobin concentration, analysis results of a health condition of a customer which will be described later, and data of health foods recommended to the same customer in the past are stored. In the commodity information DB 24f, information of health foods recommended to a customer by a pharmacist is stored. The health foods include a health food, which is required by the law to be recommended only by a pharmacist. In the recommended component DB 24g, a plurality of pieces of recommended component data (information of a component to be taken by the customer to maintain or improve health) are stored.

In the first embodiment, as shown in FIG. 2, by the input/output interface 16, the LAN cable 30, and the input/output interface 23, biological information of the customer (the measurement result of hemoglobin concentration), life information (sex, age, height, weight, eating habits, sleeping hours, and the like), analysis results of a health condition of the customer, and the like are transmitted.

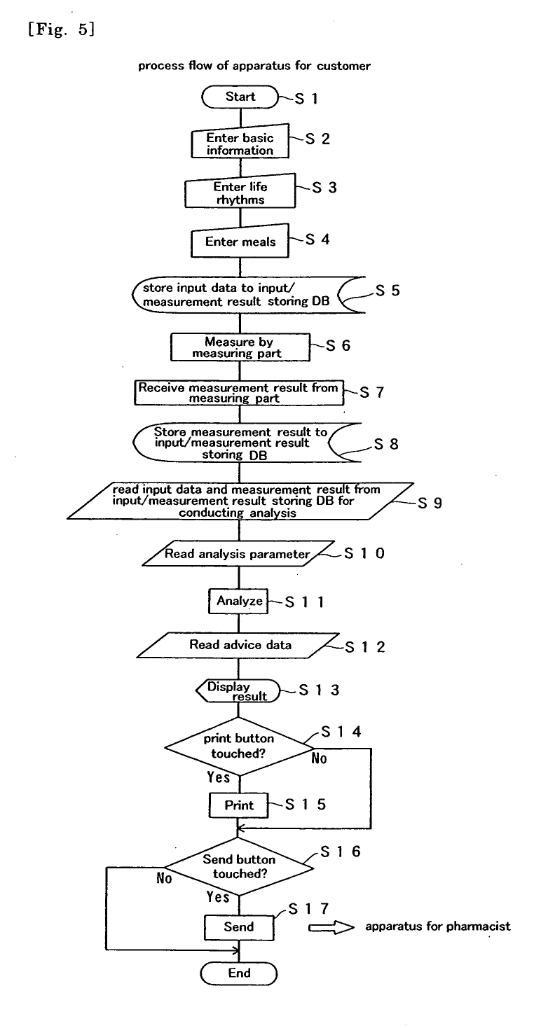

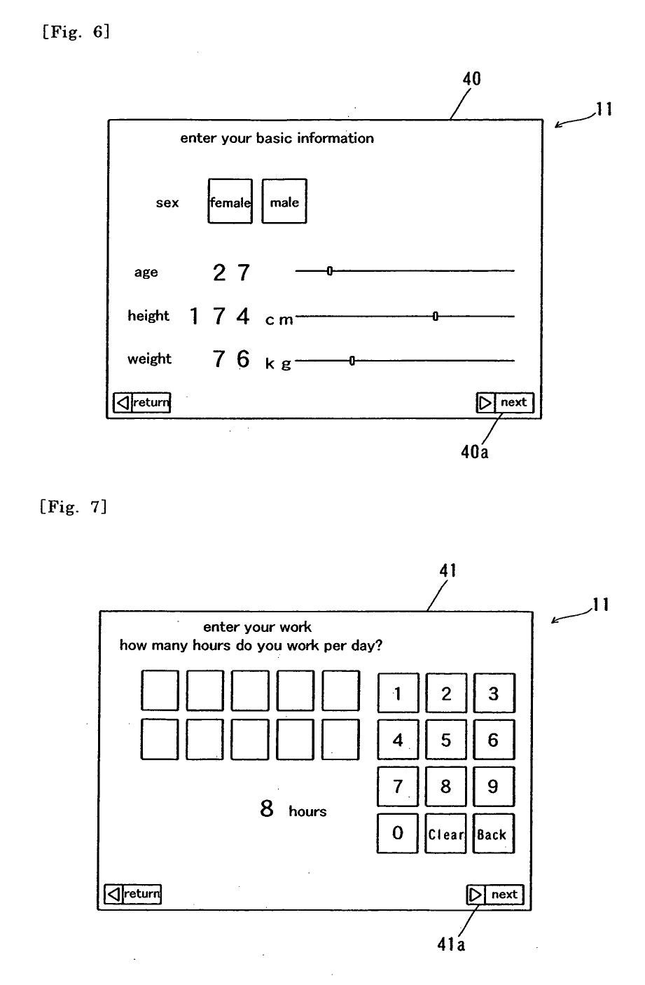

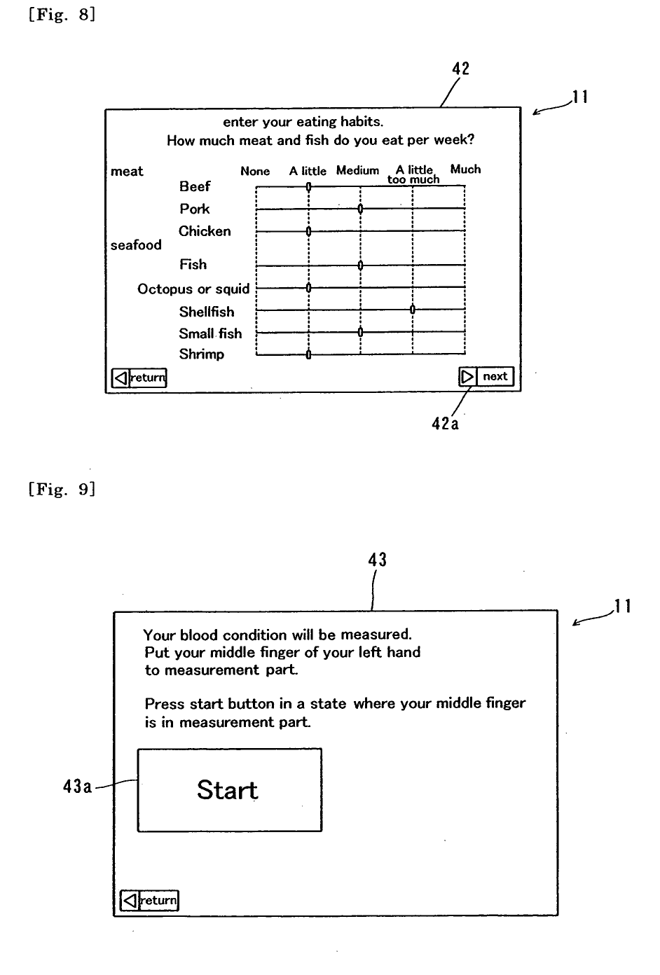

Referring now to FIGS. 1 to 3 and FIGS. 5 to 11, the process flow executed by the controller 17 of the apparatus 10 for customer in the sales support system 1 according to the first embodiment will be described. First, in step S1 shown in FIG. 5, when the customer stands in front of the apparatus 10 for customer and inserts his/her ID card into the insertion port 15a or enters his/her ID by using the touch panel 11, the process start. In the case where the process is started by using an ID card, the ID number (membership number) stored in the ID card is read by using the ID reader 15. In step S2, basic information is entered by the customer. When the customer enters the basic information, as shown in FIG. 6, a basic information entry screen 40 for entering basic information such as sex, age, height, and weight of the customer is displayed on the touch panel 11 of the apparatus 10 for customer (refer to FIG. 1). The customer enters the basic information by touching predetermined portions in the basic information entry screen 40 of the touch panel 11 with his/her finger and, after that, touches a “next” button 40a in a lower right part of the basic information entry screen 40, thereby finishing the entry of the basic information. After that, in step S3 shown in FIG. 5, the customer enters life rhythms. When the customer enters the life rhythms, a work entry screen 41 shown in FIG. 7 and a not-shown sleeping hours entry screen are displayed on the touch panel 11. In this case, first, the customer enters life rhythms such as his/her work, working hours, and the like in the work entry screen 41 shown in FIG. 7 and, after that, the customer touches a “next” button 41a in a lower right part of the work entry screen 41, thereby finishing the entry of the life rhythms. The customer enters his/her sleeping hours in the not-shown sleeping hours entry screen. Subsequently, in step S4 shown in FIG. 5, the customer enters meal data. When the customer enters meal data, as shown in FIG. 8, a meal data entry screen 42 is displayed on the touch panel 11 of the apparatus 10 for customer. The customer enters meal data on the meal data entry screen 42 in the touch panel 11 and, after that, touches a “next” button 42a in a lower right part of the meal data entry screen 42, thereby finishing the entry of the meal data. Subsequently, in step S5 shown in FIG. 5, the basic information, life rhythms, and meal data entered in steps S2 to S4 are stored in the input/measurement result storing DB 17d (refer to FIG. 3).

In step S6 shown in FIG. 5, the customer measures hemoglobin concentration by the measuring part 12. At the time of measuring hemoglobin concentration, first, as shown in FIG. 9, a measurement screen 43 is displayed on the touch panel 11 of the apparatus 10 for customer. In accordance with the instruction of the measurement screen 43, the customer inserts the middle finger of his/her left hand into the insertion part 12a of the measuring part 12 of the apparatus 10 for customer shown in FIG. 1 and touches a “start” button 43a in the measurement screen 43 of the touch panel 11 shown in FIG. 9. In such a manner, hemoglobin concentration of the customer is measured by the measuring part 12 of the apparatus 10 for customer shown in FIG. 1. After that, in step S7 shown in FIG. 5, the measurement result of hemoglobin concentration from the measuring part 12 (refer to FIG. 2) is received by the controller 17. In step S8 shown in FIG. 5, the measurement result received by the controller 17 is stored in the input/measurement result storing DB 17d (refer to FIG. 3). After that, in step S9, the basic information, life rhythms, and meal data entered in steps S2 to S4 and the measurement result of hemoglobin concentration measured in step S6 are read from the input/measurement result storing DB 17d. In step S110, analysis parameters are read from the analysis parameter DB 17c in the memory 17b.

After that, in step S11, based on the input data and the measurement result read in step S9 and the analysis parameter read in step S10, the health conditions of the customer are analyzed by an analysis algorithm such as the Bayesian network. As a result, an analysis result based on the input data and the measurement result is determined. The analysis result is data (code) for specifying one of the pluralities of advice data stored in the advice data DB 17e. Concretely, the analysis result is expressed by an alphabet, a numerical value, or the like and is associated with one of the plurality of pieces of advice data stored in the advice data DB 17e. The analysis result is associated with one of a plurality of pieces of recommended component data stored in the recommended component DB 24g. The analysis result is associated with one of a plurality of pieces of advice data for a pharmacist stored in the detailed advice DB 24d. The analysis result is associated with one of a plurality of pieces of compatibility data stored in the compatibility DB 24c. In step S12, advice data corresponding to the analysis result of the health condition of the customer determined in step S11 is selected from the advice data DB 17e in the memory 17b and read.

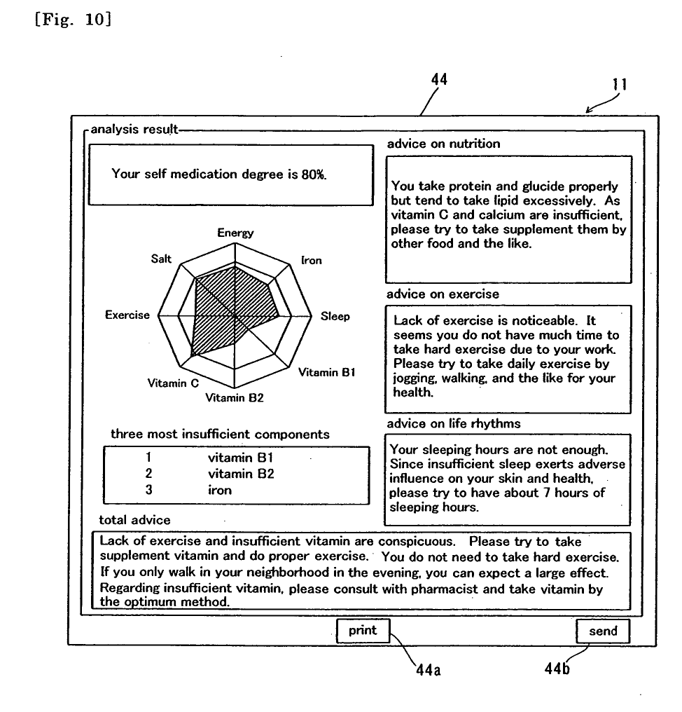

In step S13, the advice data read in step S12 is displayed. Concretely, as shown in FIG. 10, an analysis result display screen 44 showing information to suggest maintenance or improvement of the health of the customer is displayed on the touch panel 11. On the analysis result display screen 44, the degree of self medication of the customer on nutrition, exercise, and life rhythms is displayed in an upper left part. Below the degree of self medication, a total result on nutrition, exercise, and life rhythms is displayed in a graph. Below the graph, components to be taken to improve the health conditions of the customer (“components insufficient to you”) are displayed. On the right part of the analysis result display screen 44, advice is displayed on each of nutrition, exercise, and life rhythms. In a lower part of the analysis result display screen 44, general advice on the nutrition, exercise, and life rhythms is displayed. Below the general advice, a “print” button 44a and a “transmit” button 44b are disposed.

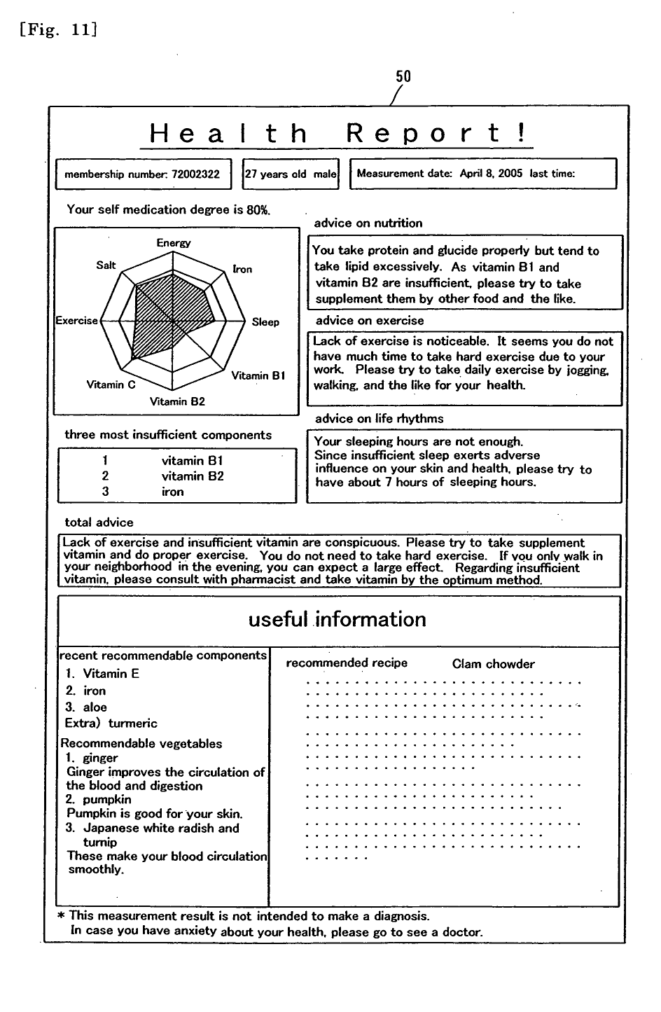

When the customer touches the “print” button 44a in step S14, a report 50 (refer to FIG. 11) is printed in step S15. The printed report 50 is ejected from the report ejection port 14a (refer to FIG. 1). In an upper part of the report 50, the membership number, age, and sex of the customer and the date of measurement are described. In an upper half of the report 50, items similar to those of the analysis result display screen 44 shown in FIG. 10 are printed. In a lower part of the report 50, “useful information” such as “recent recommended components”, “recommended vegetables”, and “recommended recipes” is printed. Below the “useful information”, notice regarding the report 50 is described.

When the customer touches the “transmit” button 44b in step S16, in step S17, ID (membership number), the input data (basic information, life rhythms, and meal data) stored in the input/measurement result DB 17d in step S5, the measurement result stored in the input/storing result DB 17d in step S8, and the analysis result determined in step S11 are transmitted via the LAN cable 30 (refer to FIG. 1) to the apparatus 20 for pharmacist (refer to FIG. 1).

Next, with reference to FIGS. 1 and 4 and FIGS. 12 to 15, the process flow of the apparatus 20 for pharmacist in the sales support system 1 according to the first embodiment will be described. The process is started when the data is transmitted from the apparatus 10 for customer.

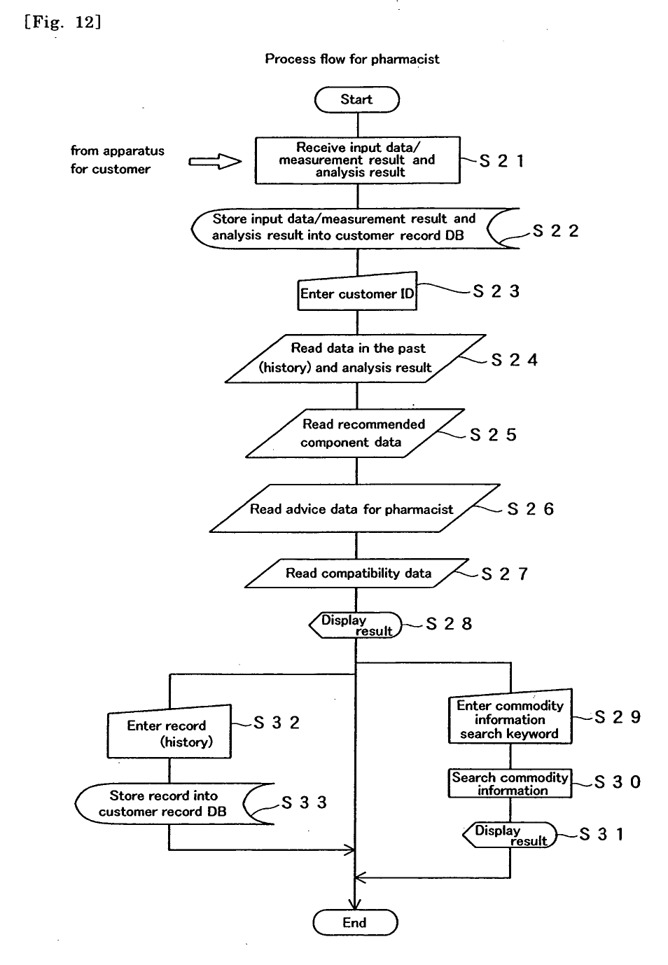

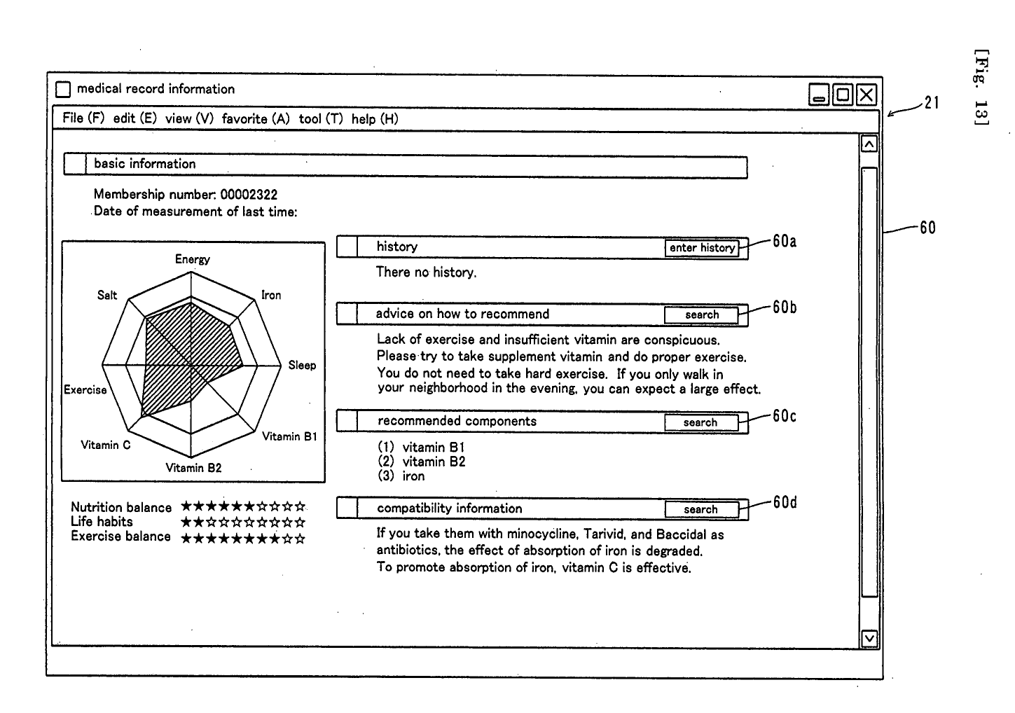

First, in step S21 in FIG. 12, the input data (basic information, life rhythms, and meal data), the measurement result, and the analysis result are received via the LAN cable 30 (refer to FIG. 1) by the apparatus 10 for customer (refer to FIG. 1). After that, in step S22, the received input data, measurement result, and analysis result are stored into the customer record DB 24e. In step S23, the ID received from the customer is entered by the pharmacist with the keyboard 22 (refer to FIG. 1). In step S24, the measurement result (including history of measurement results) and the analysis result corresponding to the entered ID are read from the customer record DB 24e (refer to FIG. 4). In step S25, recommended component data corresponding to the analysis result read in step S24 is selected from the plurality of pieces of recommended component data stored in the recommended component DB 24g (refer to FIG. 4) and read. In step S26, advice data for a pharmacist in correspondence with the analysis result read in step S24 is selected from the plurality of pieces of advice data for a pharmacist stored in the detailed advice DB 24d (refer to FIG. 4) and read. In step S27, compatibility data corresponding to the analysis result read in step S24 is selected and read from a plurality of pieces of compatibility data stored in the compatibility DB 24c (refer to FIG. 4). In step S28 shown in FIG. 12, the data read in steps S24 to S27 is displayed on a recommendation information screen 60 (refer to FIG. 13) of the touch panel 21. In an upper left part of the recommendation information screen 60, the ID (membership number) of the customer is displayed. In a left part of the recommendation information screen 60, a general result on the nutrition, exercise, and life rhythms is displayed. In an upper part on the right side of the recommendation information screen 60, history is displayed. In the case where the customer having the same membership number used the sales support system 1 in the past, health foods recommended to the customer having the same membership number last time are displayed in the history. On the right side of “history”, a “history input” button 60a for displaying a picture on which history of the customer is input is displayed. Below the history, advice data for a pharmacist read in step S26 (displayed as “advice on recommendation” on the screen 60), recommended component data read in step S25 (displayed as “recommended components” on the screen 60), and compatibility data read in step S27 (displayed as “compatibility information” on the screen 60) are displayed. In the column of recommended components, the first to third recommended components are displayed. In the column of compatibility, information on deterioration and promotion of the effect of a recommended commodity, side effects, and the like in the case where the recommended components are taken with other drug, health food, and the like is displayed. In the columns of the advice on recommendation, the recommended components, and the compatibility, “search” buttons 60b to 60d for obtaining more-detailed information are provided, respectively.

By displaying such an information screen 60, the pharmacist can determine which advice to be given to maintain or improve the health to the customer on the basis of the information displayed in “advice on recommendations. The pharmacist can select a commodity including any of the components displayed in the column as a commodity to be purchased by the customer in order to maintain or improve health from the information displayed in “recommended components” and recommend the commodity to the customer.

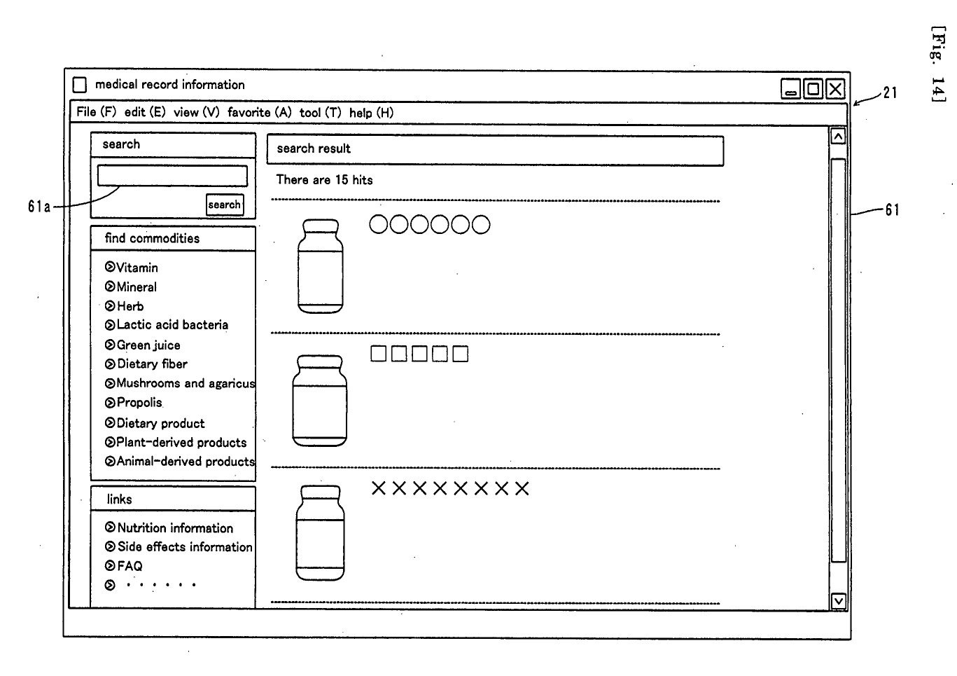

In step S28 shown in FIG. 12, the pharmacist may recommend a commodity (for example, a health food) on the basis of information (for example, recommended components) displayed on the recommendation information screen 60 shown in FIG. 13 or obtain more-detailed information on a health food including any of the recommended components or the like. For example, in the case where the pharmacist retrieves a health food including the recommended component, by touching the “search” button 60c of the recommended components, the process of the apparatus 20 for pharmacist advances to step S29 shown in FIG. 12. In step S29, a commodity search screen 61 as shown in FIG. 14 is displayed. In a center portion of the commodity search screen 61, a plurality of kinds (15 kinds in the example of FIG. 14) of health foods including the recommended components are displayed so as to be scrolled. The pharmacist may select a proper commodity from the commodities displayed, and recommend the selected one to the customer. In an upper left part of the commodity search screen 61, a search box 61a for keyword search (commodity information search) is provided.

When a keyword is entered in the search box 61a in the commodity search screen 61, in step S30 shown in FIG. 12, the apparatus 20 for pharmacist retrieves commodity information. For example, when a keyword such as “anemia”, “diet”, or “allergy” is entered in the search box 61a, a health food containing a recommended component and effective on anemia, diet, allergy, and the like is read from the commodity information DB 24f (refer to FIG. 4). In step S31, the apparatus 20 for pharmacist displays the information on the health food read from the commodity information DB 24f (refer to FIG. 4) in the center portion of the touch panel 21.

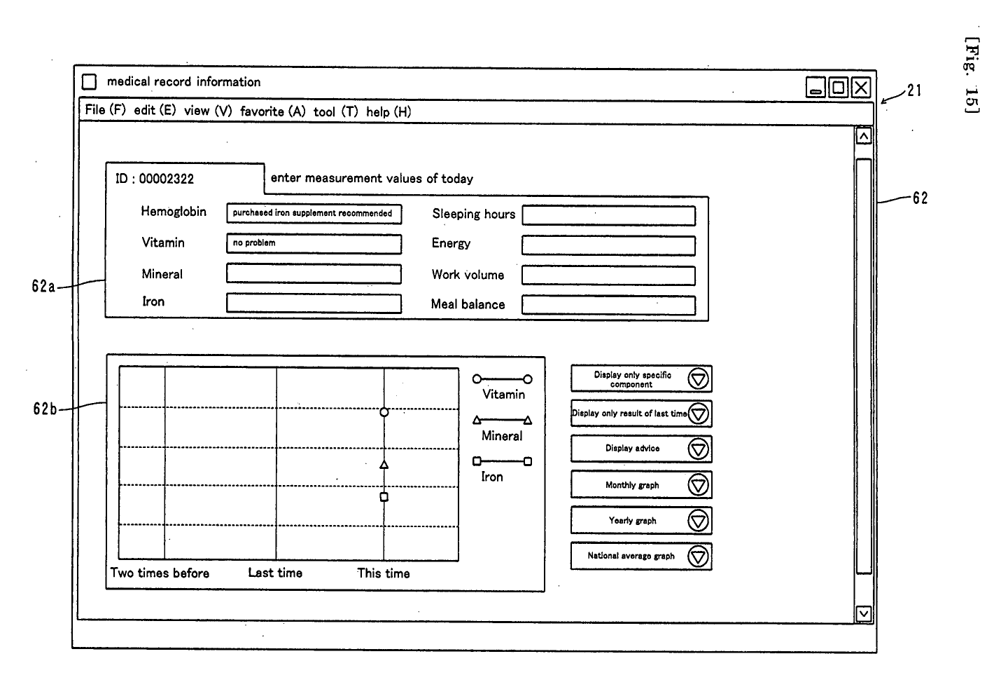

In the case where the pharmacist recommends the commodity to the customer on the basis of the recommendation information screen 60 (refer to FIG. 13) displayed in step S28 shown in FIG. 12 and then stores the situation (history) of the customer, the pharmacist touches the “history input” button 60a of the history in the recommendation information screen 60 with his/her finger. The process of the apparatus 20 for pharmacist advances to step S32. In step S32 shown in FIG. 12, the apparatus 20 for pharmacist displays a history displays a detailed history screen 62 on the touch panel 21 as shown in FIG. 15. Since a history entry box 62a for entering the life rhythms of the customer and a history of recommended or purchased commodities is provided in an upper part of the detailed history screen 62, the pharmacist can view the situation of the customer. In a lower right portion of the detailed history screen 62, a plurality of buttons for displaying advice data including histories are disposed. On the left side of the plurality of buttons, a graph display portion 62b showing a graph of amounts of components taken by the customer is disposed. The situation of the customer entered in step S32 is stored into the customer record DB 24e in step S33.

In the first embodiment, as described above, the apparatus 20 for pharmacist has the controller 24 for obtaining information for supporting selection by the pharmacist of a commodity to be purchased by the customer to maintain or improve health (information stored in the commodity information DB 24f and the recommendation component DB 24g) on the basis of life information entered by the touch panel 11 of the apparatus 10 for customer and the hemoglobin concentration (biological information) measured by the measuring part 12, and the touch panel 21 for displaying the information for supporting selection by the pharmacist of a commodity to be purchased by the customer, which is obtained by the controller 24. With the configuration, the pharmacist can view information for supporting selection by the pharmacist of a commodity to be purchased by the customer, which is determined on the basis of the life information entered by the customer and the measured biological information and displayed on the touch panel 21 of the apparatus 20 for pharmacist. Therefore, it becomes easier for the pharmacist to select a commodity suitable for the customer on the basis of the information for supporting selection by the pharmacist of the commodity to be purchased by the customer and recommend the commodity to the customer. On the other hand, when the pharmacist recommends a commodity on the basis of the life information and the biological information of the customer himself/herself, the customer can understand and purchase the commodity.

In the first embodiment, the apparatus 10 for customer is provided with the controller 17 for obtaining advice data to the customer in correspondence with the measured hemoglobin concentration (biological information) and the entered life information, and is constructed so that the advice data obtained by the controller 17 can be displayed or printed. With the configuration, the customer can determine whether he/she buys the commodity recommended by the pharmacist or not on the basis of the displayed or printed advice data. Thus, different from the case where a commodity is simply recommended by a pharmacist, the customer can understand why the commodity is necessary for the customer, so that the customer is convinced to purchase the commodity.

In the first embodiment, the controller 24 for obtaining advice data for a pharmacist, which is used by a pharmacist to advise the method of maintaining or improving the health of the customer is provided, and the touch panel 21 of the apparatus 20 for pharmacist is constructed so as to display the advice data for a pharmacist, which is obtained by the controller 24. With the configuration, the pharmacist can determine how to advise the customer to maintain or improve health on the basis of the advice data for the pharmacist.

### Second Embodiment

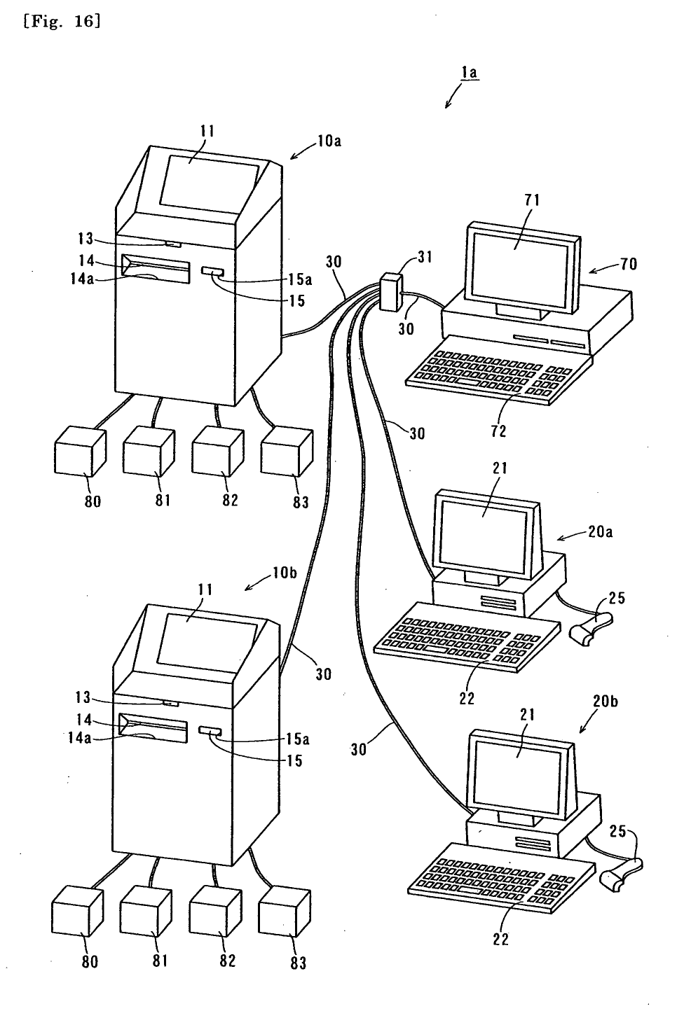

The configuration of a sales support system of a second embodiment will be described with reference to FIGS. 16 to 20. In the second embodiment, different from the first embodiment, a plurality of apparatuses for customers and a plurality of apparatuses for pharmacists are connected to a single server, and data collected from the plurality of apparatuses for customers is managed by the single server.

In the second embodiment, as shown in FIG. 16, a sales support system 1a is a system for supporting work of a pharmacist, and includes an apparatus 10a for customer, another apparatus 10b for customer, an apparatus 20a for pharmacist, another apparatus 20b for pharmacist, and one server 70. The sales support system 1a has a plurality of other apparatuses 10b for customer and a plurality of other apparatuses 20b for pharmacist. However, for simplification of the drawing, in the second embodiment, only one apparatus 10b for customer and one apparatus 20b for pharmacist are shown. The apparatuses 10a and 10b for customer and the apparatuses 20a and 20b for pharmacist are connected to the server 70 via the LAN cables 30 and a hub 31.

In the second embodiment, the apparatus 10a for customer and the apparatus 20a for pharmacist are established in a predetermined pharmacy, and the another apparatus 10b for customer and the another apparatus 20b for pharmacist are established in another pharmacy belonging to the same group company to which the predetermined pharmacy also belongs. The server 70 is established in a headquarter controlling the group company, a data center centrally handling various data, or the like. With the configuration, data collected from all of the apparatuses 10a and 10b established in pharmacies belonging to the group company can be managed by the single server 70. The apparatuses 10a and 10b for customer have the same configuration, and the apparatuses 20a and 20b for pharmacist have the same configuration. As components designated with the same reference numerals as those in the first embodiment, the same functions as those in the first embodiment can be used.

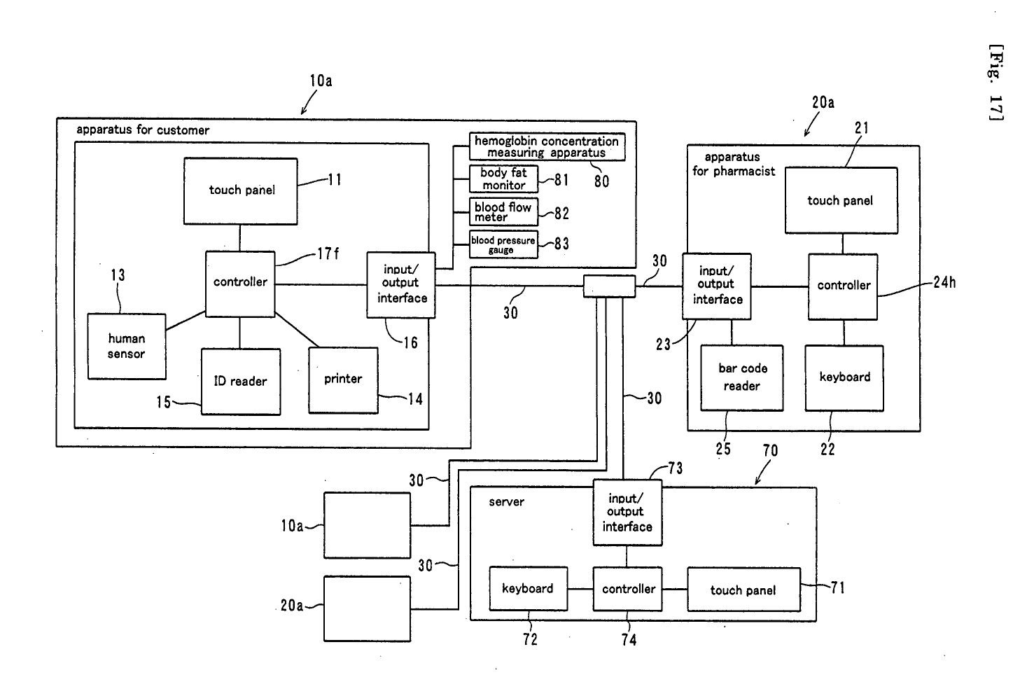

In the second embodiment, the apparatus 10a for customer has, as shown in FIG. 17, the touch panel 11, the human sensor 13, the printer 14, the ID reader 15, the input/output interface 16 connected to the LAN cable 30, and a controller 17f. The touch panel 11, human sensor 13, printer 14, ID reader 15, and input/output interface 16 are connected to the controller 17f.

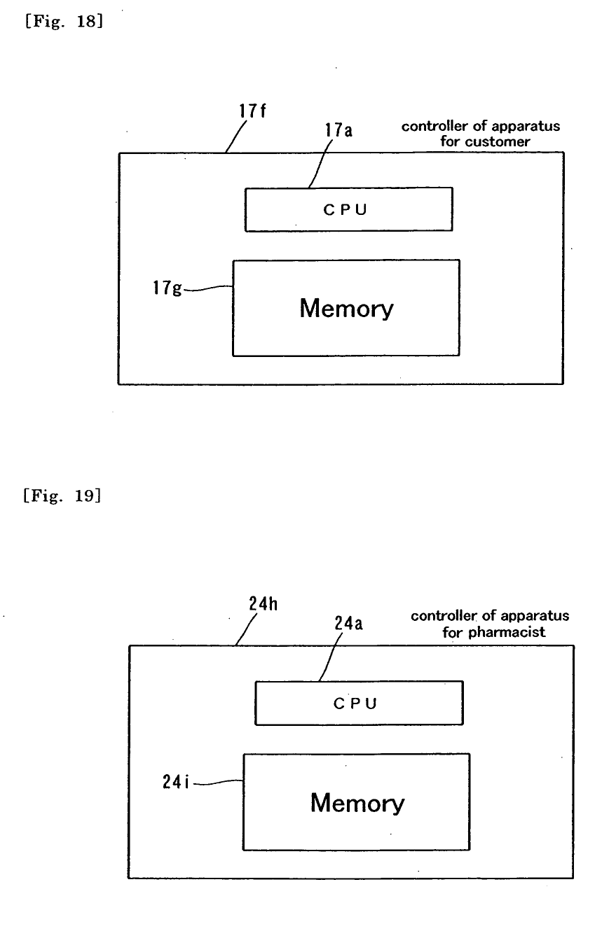

In the second embodiment, to the input/output interface 16 of the apparatus 10a for customer, a hemoglobin concentration measuring apparatus 80, a body fat monitor 81, a blood flow meter 82, and a blood pressure gauge 83 for measuring biological information of the customer are connected, and measurement results of hemoglobin concentration, percentage of body fat, blood flow, and a blood pressure value are transmitted. As shown in FIG. 18, the controller 17f of the apparatus 10a for customer includes the CPU 17a and a memory 17g.

In the second embodiment, as shown in FIG. 17, the apparatus 20a for pharmacist includes the touch panel 21, keyboard 22, input/output interface 23 connected to the LAN cable 30, a controller 24h, and a bar code reader 25 connected to the input/output interface 23. The touch panel 21, keyboard 22, and input/output interface 23 are connected to the controller 24h. The controller 24h in the apparatus 20a for pharmacist includes, as shown in FIG. 19, the CPU 24a and a memory 24i.

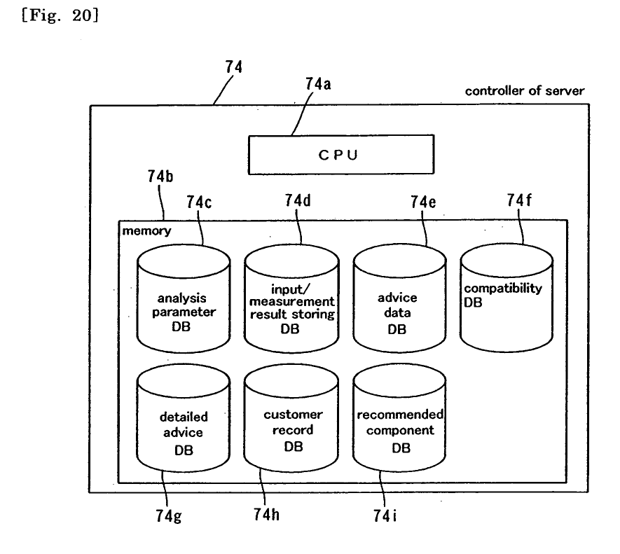

In the second embodiment, as shown in FIG. 17, the server 70 includes a touch panel display (hereinafter, referred to as a touch panel) 71 and a keyboard 72. The server 70 has therein an input/output interface 73 connected to the LAN cable 30. To the touch panel 71, keyboard 72, and input/output interface 73, a controller 74 is connected. As shown in FIG. 20, the controller 74 includes a CPU 74a and a memory 74b. The memory 74b includes an analysis parameter DB 74c, an input/measurement result storing DB 74d, an advice data DB 74e, a compatibility DB 74f, a detailed advice DB 74g, a customer record DB 74h, and a recommendation component DB 74i.

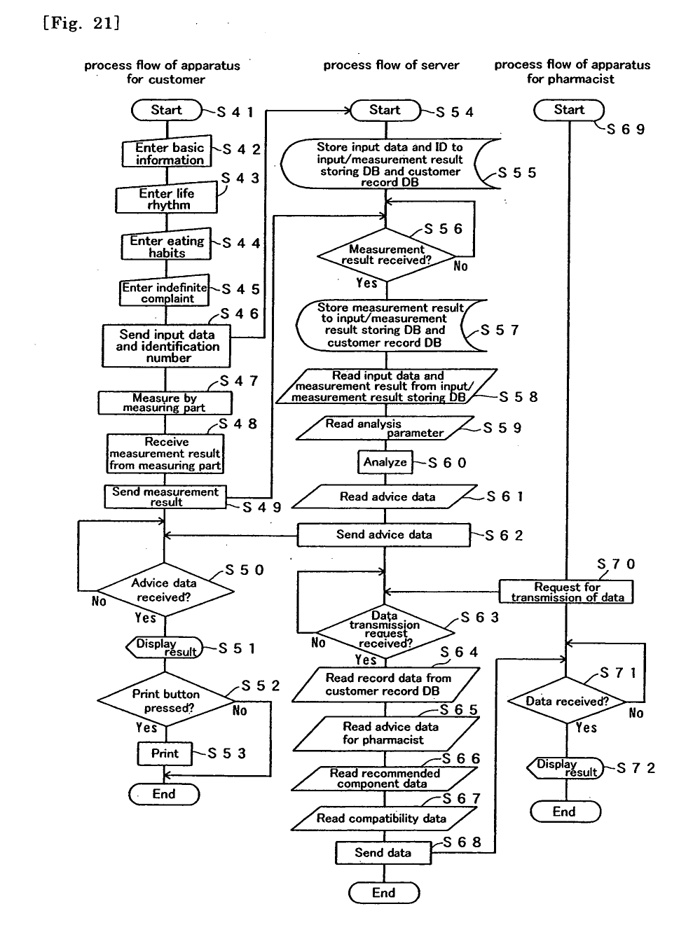

The process flow of the sales support system 1a according to the second embodiment will now be described. First, with reference to FIGS. 6 to 10, and FIGS. 16, 21, and 22, the process flow executed by the controller 17f in the apparatus 10a for customer in the sales support system 1a according to the second embodiment will be described. Processes in steps S41 to S44 shown in FIG. 21 are similar to those in steps S1 to S4 in the first embodiment shown in FIG. 5. Specifically, in step S41 shown in FIG. 21, when the customer stands in front of the apparatus 10a for customer and inserts his/her ID card into the insertion port 15a or enters the ID by using the touch panel 11, the process is started. In the case where the process is started by using an ID card, the ID number (membership number) stored in the ID card is read by the ID reader 15. Then, in step S42, basic information is entered by the customer. When the customer enters the basic information, as shown in FIG. 6, the basic information entry screen 40 for entering basic information such as sex, age, height, and weight of the customer is displayed on the touch panel 11 of the apparatus 10a for customer (refer to FIG. 16). The customer enters the basic information by touching predetermined portions in the basic information entry screen 40 of the touch panel 11 with his/her finger and, after that, touches a “next” button 40a in a lower right part of the basic information entry screen 40. At this time, information by which the customer can be specified, such as the name and address of the customer is not entered. The entry of the basic information completes. After that, in step S43 shown in FIG. 21, the customer enters life rhythms. When the customer enters the life rhythms, the work entry screen 41 shown in FIG. 7 and a not-shown sleeping hours entry screen are displayed on the touch panel 11. In this case, first, the customer enters life rhythms such as his/her work, working hours, and the like in the work entry screen 41 shown in FIG. 7 and, after that, touches the “next” button 41a in the lower right part of the work entry screen 41, thereby finishing the entry of the life rhythms. The customer enters his/her sleeping hours in the not-shown sleeping hours entry screen. Subsequently, in step S44, the customer enters meal data. When the customer enters meal data, as shown in FIG. 8, the meal data entry screen 42 is displayed on the touch panel 11 of the apparatus 10a for customer. The customer enters meal data on the meal data entry screen 42 in the touch panel 11 and, after that, touches the “next” button 42a in the lower right part of the meal data entry screen 42, thereby finishing the entry of the meal data.

After that, in the second embodiment, different from the first embodiment, in step S45 shown in FIG. 21, a plurality of questions regarding signs (indefinite complaint) of the customer are displayed on the touch panel 11 as information related to the life of the customer, and the customer enters answers to the plurality of questions related to indefinite complaint. As questions related to the signs (indefinite complaint) of the customer, “cold in hands, feet, and the back”, “sleepiness”, and the like ca be mentioned. Subsequently, in step S46, the ID of the customer, basic information, life rhythms, meal data, and indefinite complaint entered in steps S41 to S45 are transmitted to the server 70 (refer to FIG. 16). In step S46, the identification number indicative of the analysis of this time is determined and transmitted to the server 70.

In step S47 shown in FIG. 21, screens for encouraging the customer to perform measurement by the hemoglobin concentration measuring apparatus 80, body fat monitor 81, blood flow meter 82, and blood pressure gauge 83 are sequentially displayed on the touch panel 11. In accordance with the screens, the customer measures hemoglobin concentration, percentage of body fat, blood flow, and blood pressure value by the hemoglobin concentration measuring apparatus 80 (refer to the FIG. 16), body fat monitor 81, blood flow meter 82, and blood pressure gauge 83, respectively. At the time of measuring hemoglobin concentration, first, as shown in FIG. 9, the measurement screen 43 is displayed on the touch panel 11 of the apparatus 10a for customer. In accordance with the instruction of the measurement screen 43, the customer inserts the middle finger of his/her left hand into an insertion part (not shown) of the hemoglobin concentration measuring apparatus 80 of the apparatus 10a for customer and touches the “start” button 43a in the measurement screen 43 of the touch panel 11 shown in FIG. 9. In such a manner, hemoglobin concentration of the customer is measured by the hemoglobin concentration measuring apparatus 80. The percentage of body fat, blood flow, and blood pressure value are also sequentially measured in accordance with instructions in the measurement screens on the touch panel 11 in a manner similar to the measurement of hemoglobin concentration. After that, in step S48 shown in FIG. 21, the measurement results of the hemoglobin concentration, percentage of body fat, blood flow, and blood pressure value from the hemoglobin measuring apparatus 80, body fat monitor 81, blood flow meter 82, and blood pressure gauge 83 are received by the controller 17f. In step S49 shown in FIG. 21, the measurement results received by the controller 17f are transmitted to the server 70.

After that, in step S50, whether advice data is received from the server 70 or not is determined. In the case where it is determined in step S50 that no advice data is received from the server 70, the determination repeats. In the case where it is determined in step S50 that advice data is received from the server 70, the received advice data is displayed in step S51. Concretely, as shown in FIG. 10, the analysis result display screen 44 similar to that of the first embodiment, which shows information for suggesting maintenance or improvement in the health of the customer, is displayed on the touch panel 11.

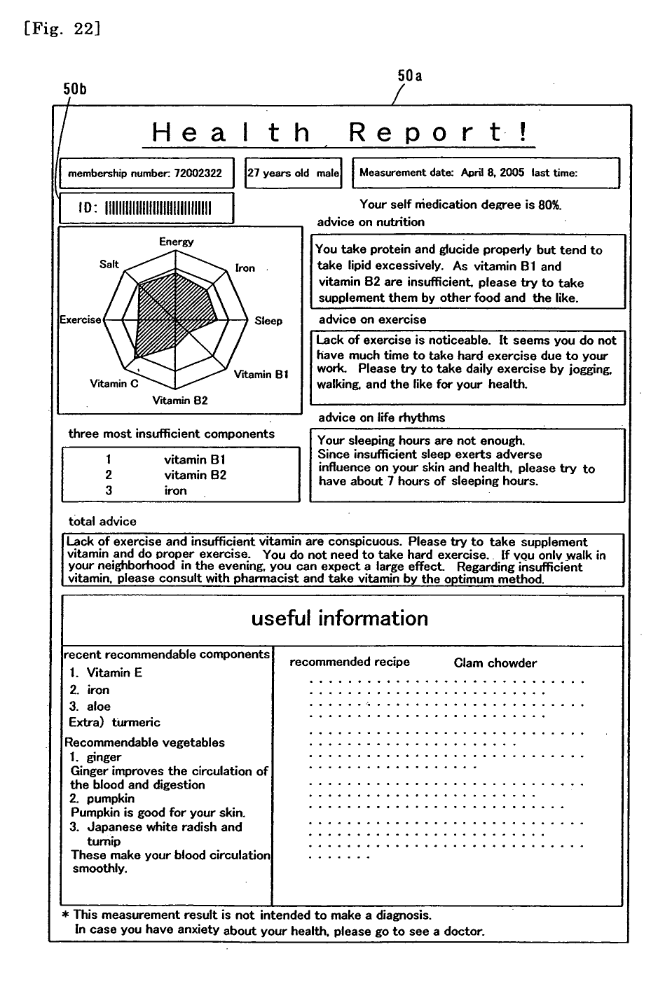

When the customer touches the “print” button 44a in the analysis result screen 44 shown in FIG. 10 in step S52, a report 50a (refer to FIG. 22) is printed in step S53. The printed report 50a is ejected from the report ejection port 14a (refer to FIG. 16). In the report 50a according to the second embodiment shown in FIG. 16, different from the report 50 according to the first embodiment shown in FIG. 11, a bar code 50b including the identification number indicative of the analysis of this time determined in step S46 is displayed below the membership number of the customer. In the other portion of the report 50a of the second embodiment, information similar to that of the report 50 according to the first embodiment shown in FIG. 11 is printed.

Next, with reference to FIGS. 16, 20, and 21, the process flow of the server 70 in the sales support system 1a according to the second embodiment will be described. The process is started when the ID of the customer, basic information, life rhythms, meal data, and indefinite complaint entered in steps S41 to S45 (refer to FIG. 21) from the apparatus 10a for customer and the identification number determined in step S46 are transmitted. The process is a process for a set of the apparatus 10a for customer and the apparatus 20a for pharmacist. When input data from the another apparatus 10b for customer or the apparatus 20b for pharmacist is transmitted, the process on the apparatus 10b for customer and the apparatus 20b for pharmacist are performed in parallel with the above process.

First, in step S54, the input data (the ID of the customer, basic information, life rhythms, meal data, and indefinite complaint) and the identification number are received via the LAN cable 30 (refer to FIG. 16) and the hub 31 from the apparatus 10a for customer (refer to FIG. 16), thereby starting the process in the server 70. In step S55, the received input data is stored so as to be associated with the identification number into the input/measurement result storing DB 74d and the customer record DB 74h in the memory 74b of the server 70 (refer to FIG. 20). In step S56, whether the measurement result is received from the apparatus 10a for customer or not is determined. When it is determined in step S56 that the measurement result has not been received from the apparatus 10a for customer, the determination is repeated. When it is determined in step S56 that the measurement result is received from the apparatus 10a for customer, in step S57, the received measurement result is stored so as to be associated with the identification number in the input/measurement result storing DB 74d and the customer record DB 74h in the memory 74b of the server 70.

In step S58, the ID of the customer, basic information, life rhythms, meal data, and indefinite complaint entered in steps S41 to S45 and the measurement result (including history of measurement results) measured in step S47 are read from the input/measurement result storing DB 74d (refer to FIG. 20) in the memory 74b. After that, in step S59, the analysis parameter is read from the analysis parameter DB 74c in the memory 74b. In step S60, based on the input data and the measurement result read in step S58 and the analysis parameter read in step S59, the health conditions of the customer are analyzed by an analysis algorithm such as the Bayesian network. As a result, an analysis result based on the input data and the measurement result is determined. The analysis result is data (code) for specifying one from the plurality of pieces of advice data stored in the advice data DB 74e (refer to FIG. 20). Concretely, the analysis result is expressed by an alphabet, a numerical value, or the like and is associated with one of the plurality of pieces of advice data stored in the advice data DB 74e. The analysis result is associated with one of a plurality of pieces of recommended component data stored in the recommended component DB 74i (refer to FIG. 20). The analysis result is associated with one of a plurality of pieces of advice data for a pharmacist stored in the detailed advice DB 74g (refer to FIG. 20). The analysis result is associated with one of a plurality of pieces of compatibility data stored in the compatibility DB 74f (refer to FIG. 20). The analysis result is associated with the identification number received in step S54.

In step S61, advice data corresponding to the analysis result of the health condition of the customer determined in step S60 is selected from the advice data DB 74e (refer to FIG. 20) and read. After that, in step S62, the advice data read in step S61 is transmitted to the apparatus 10a for customer. In step S63, whether data requesting for transmission of data from the apparatus 20a for pharmacist is received or not is determined. The data requesting for transmission of data is included in the identification number indicative of analysis of this time entered to the apparatus 20a for pharmacist. The identification number is used for identifying the input data, measurement result, advice data for pharmacist, recommended component data, and compatibility data steps S64 to S67. In the case where it is determined in step S63 that data requesting for transmission of data from the apparatus 20a for pharmacist is not received, the determining operation repeats. In the case where it is determined in step S63 that data requesting for transmission of data from the apparatus 20a for pharmacist is received, in step S64, input data and the measurement result (including history of measurement results) corresponding to the identification number transmitted from the apparatus 20a for pharmacist are read from the customer record DB 74h (refer to FIG. 20).

In step S65, advice data for a pharmacist corresponding to the analysis result corresponding to the identification number transmitted from the apparatus 20a for pharmacist is selected and read from a plurality of pieces of advice data for pharmacist stored in the detailed advice DB 24d (refer to FIG. 20). In step S66, recommended component data corresponding to the analysis result corresponding to the identification number transmitted from the apparatus 20a for pharmacist is selected and read from a plurality of pieces of recommended component data stored in the recommended component DB 74i (refer to FIG. 20). After that, in step S67, compatibility data corresponding to the analysis result corresponding to the identification number transmitted from the apparatus 20a for pharmacist is selected and read from a plurality of pieces of compatibility data stored in the compatibility DB 74f (refer to FIG. 20). In step S68, the data read in steps S64 to S67 is transmitted to the apparatus 20a for pharmacist.

With reference to FIGS. 13, 16, 21, and 22, the process flow of the apparatus 20a for pharmacist of the sales support system 1a according to the second embodiment will be described.

First, the pharmacist enters the identification number to the apparatus 20a for pharmacist in step S69, thereby starting the process flow of the apparatus 20a for pharmacist. The identification number may be entered by using the keyboard 22 (refer to FIG. 16) or by reading the bar code 50b (refer to FIG. 22) printed on the report 50a printed in step S53 by the bar code reader 25. In step S70, data requesting for transmission of data is transmitted to the server 70. The data requesting for transmission of data includes the identification number entered in step S69. In step S71, if the data read in steps S64 to S67 is received from the server 70 or not is determined. When it is determined in step S71 that data read in steps S64 to S67 is not received from the server 70, the determining operation repeats.

After that, when it is determined in step S71 that the data read in steps S64 to S67 is received, in step S72, the data received in step S71 is displayed on a screen similar to the recommendation information screen 60 (refer to FIG. 13) of the first embodiment shown in FIG. 13.

When such an information screen 60 is displayed, thereby, the pharmacist can determine advice to give in order to maintain or improve the health of the customer on the basis of the information displayed in “advice on how to recommend”. On the basis of the information displayed in “recommended components”, the pharmacist selects a commodity containing the component displayed in the column as a commodity to be purchased by the customer to maintain or improve his/her health, and can recommend the commodity to the customer.

In the second embodiment, as described above, the apparatus 10a for customer and the server 70 are connected to each other via the LAN cable 30 and the hub 31, and the apparatus 20a for pharmacist and the server 70 are connected to each other via the LAN cable 30 and the hub 31. With the configuration, information for supporting selection by the pharmacist of a commodity to be purchased by the customer to maintain or improve his/her health (information stored in the recommend component DB 74i) determined by the controller 4 in the server 70 on the basis of the life information entered by the customer in the apparatus 10a for customer and the biological information measured is transmitted from the server 70 to the apparatus 20a for pharmacist and can be easily displayed on the touch panel 21 of the apparatus 20a for pharmacist. Consequently, the pharmacist can view the information for supporting selection by the pharmacist of the commodity to be purchased by the customer displayed on the touch panel 21 of the apparatus 20a for pharmacist. Therefore, the pharmacist can easily select a commodity suitable for the customer and recommend it to the customer on the basis of the information for supporting the selection by the pharmacist of the commodity to be purchased by the customer. On the other hand, when the pharmacist recommends a commodity on the basis of the life information and biological information of the customer himself/herself, the customer is convinced to purchase the commodity.

In the second embodiment, the server 70 is connected to the plurality of apparatuses 10a and 10b for customer and the plurality of apparatuses 20a and 20b corresponding to the plurality of apparatuses 10a and 10b for customer, respectively, so that communications can be performed. With the configuration, life information collected from all of the apparatuses 10a and 10b for customer disposed in pharmacies belonging to a group company can be managed by a single server 70.

In the second embodiment, by providing the memory 74b for storing information on a commodity to be purchased by the customer to maintain or improve his/her health (information stored in the recommended component DB 74i) in the server 70, a predetermined recommended component can be selected from the recommended component DB 74i without performing communications with another apparatus on the basis of the life information received from the apparatus 10a for customer and the measured biological information. Thus, the process can be performed at high speed. [00851 In the second embodiment, the pharmacist can display the recommendation information screen 60 only by reading the bar code 50b printed on the report 50a, so that the process becomes easy. In addition, the pharmacist does not obtain personal data for specifying the name, address, and the like of the customer, so that it is unnecessary to manage the personal data.

The other effects of the second embodiment are similar to those of the foregoing first embodiment.

The embodiments disclosed here are therefore to be considered in all respects as illustrative and not restrictive. The scope of the invention is indicated by the appended claims rather than by the foregoing description of the embodiments, and all changes, which come within the meaning, and range of equivalency of the claims are therefore intended to be embraced therein.

For example, the case of using hemoglobin concentration as biological information of the customer in the first embodiment and using hemoglobin concentration, percentage of body fat, blood flow amount, and blood pressure value as biological information of the customer in the second embodiment has been described. However, the present invention is not limited to the case. As biological information, a blood sugar value, a body temperature, pulse, and the like other than the hemoglobin concentration, percentage of body fat, blood flow amount, and blood pressure value may be used.

In the first and second embodiments, the example of using the Bayesian network as an analysis algorithm for analyzing the health condition of a customer on the basis of input data, measurement data, and analysis parameter in the apparatus for customer has been described. The present invention however is not limited to the example. The health condition of a customer may be analyzed by using an analysis algorithm other than the Bayesian network.

In the first and second embodiments, the example of mounting the sales support system in a pharmacy has been described. However, the invention is not limited to the example. The sales support system may be established in a convenience store, a sports gym, a hospital, a supermarket, and the like. In the case of using the sales support system in a convenience store or a supermarket, the apparatus for pharmacist is used as an apparatus for a clerk. In the case of using the sales support system in a sports gym, the apparatus for pharmacist is used as an apparatus for an instructor. In the case of using the sales support system in a hospital, the apparatus for pharmacist is used as an apparatus for doctor. In this case, a commodity like food such as vegetables other than the health food, drug, fitness equipment, or the like may be sold.

Although the example where a pharmacist as a sales person recommends health food is described in the first and second embodiments, the invention is not limited to the example. A doctor in a hospital or the like may recommend health food.

Although the example of retrieving health food in the apparatus for pharmacist has been described in the first embodiment, the present invention is not limited to the example. Other than the health food, food such as vegetables or drugs may be retrieved.

In the foregoing first embodiment, the process of determining recommended component data from an analysis result determined on the basis of input data (sex, age, height, weight, eating habits, work, sleeping hours, and the like) and the measurement result is performed in the apparatus for pharmacist. In the second embodiment, the example of performing the process by the server has been described. The present invention is not limited to the examples. The process of determining recommended component data from the analysis result determined on the basis of the input data and the measurement result may be performed by the apparatus for customer.

In the foregoing first embodiment, the process of determining an analysis result on the basis of input data (sex, age, height, weight, eating habits, work, sleeping hours, and the like) and the measurement result is performed in the apparatus for customer. In the second embodiment, the example of performing the process by the server has been described. The present invention is not limited to the examples. The process of determining analysis result on the basis of the input data and the measurement result may be performed by the apparatus for pharmacist. In this case, the apparatus for customer may receive an analysis result from the apparatus for pharmacist and, on the basis of the analysis result, may select advice data from the advice data DB or, on the basis of the analysis result, may receive a recommended component selected by the apparatus for pharmacist from the apparatus for pharmacist.

In the first embodiment, the example in which the apparatus for customer analyzes the health condition of a customer on the basis of the biological information (hemoglobin concentration, percentage of body fat, blood flow amount, and blood pressure value) as measurement data and life information (sex, age, height, weight, eating habits, sleeping hours, and the like) as input data has been described. The invention is not limited to the example but the health condition of a customer may be analyzed on the basis of only life information.

In the first embodiment, the example in which a pharmacist retrieves (extracts) health food to be recommended to a customer on the commodity search screen of the apparatus for pharmacist has been described. The invention is not limited to the example. Alternately, health food to be recommended to a customer may be automatically retrieved (extracted) on the basis of the measurement data and the analysis result and displayed.

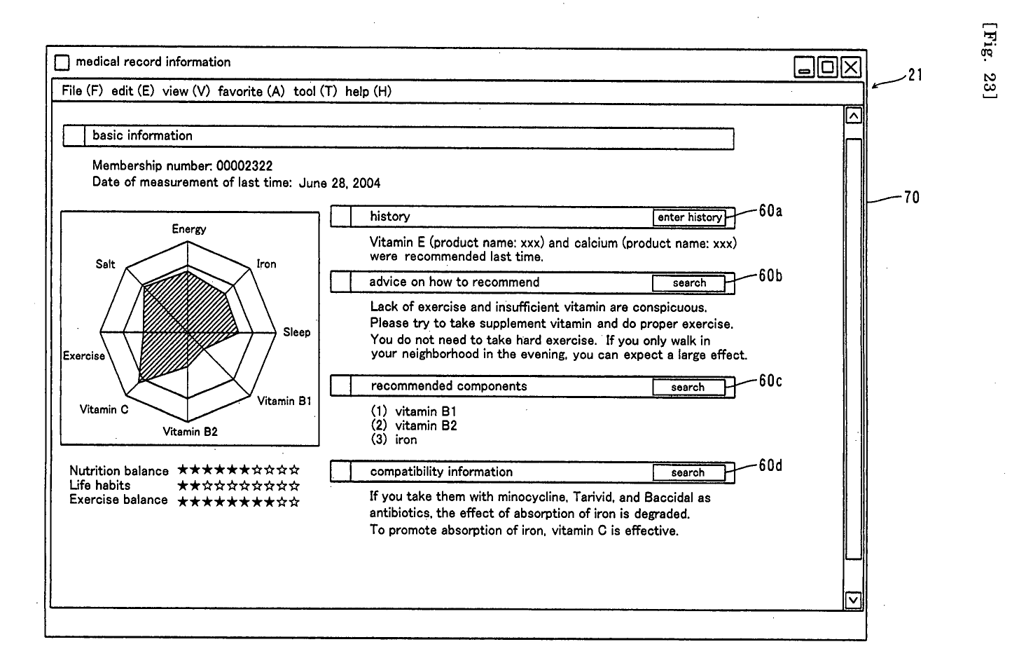

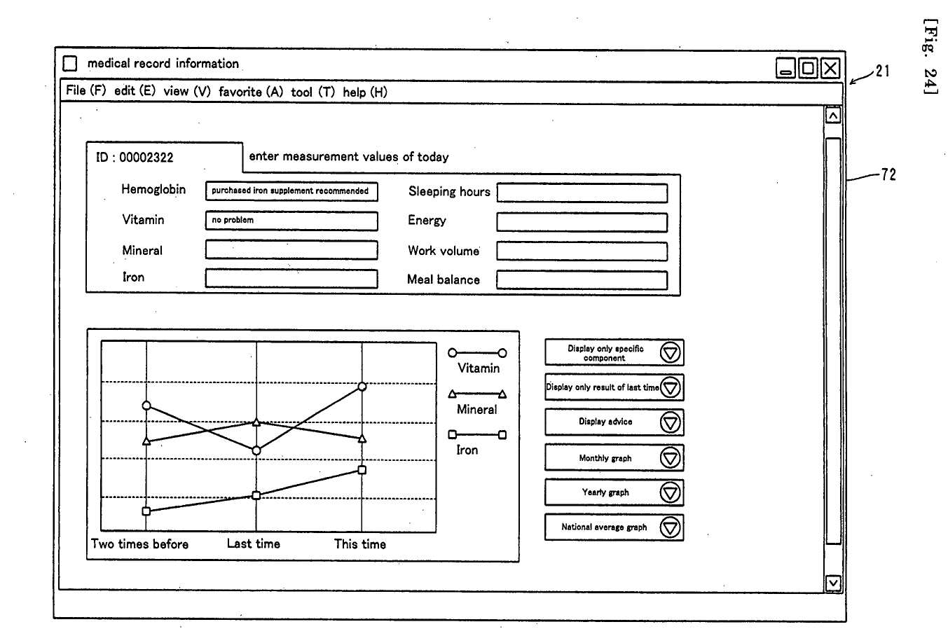

In the first embodiment, the case where a new customer uses the sales support system has been described as an example. Consequently, no history is displayed on the recommendation information screen 60 shown in FIG. 13, and the analysis result of last time and that of two times before are not shown in the graph of analysis results on the detailed history screen 62 shown in FIG. 15. However, in the case where a customer used the sales support system before, in step S24 shown in FIG. 12, measurement data in the past of the customer, analysis results, information of health food recommended to the customer, and the like are read from the customer record DB 24e. As shown in FIGS. 23 and 24, the health food recommended to the customer last time is displayed in the history on the recommendation information screen 70 (refer to FIG. 23) and analysis results of two times before, last time, and this time are displayed in a graph on the detailed history screen 72 (refer to FIG. 24). By the display, a change with time in the health condition of the customer can be grasped.

Although the example of retrieving health food containing a recommended component has been described in the first embodiment, the invention is not limited to the example. Alternately, advice for a pharmacist or compatibility information may be retrieved. In this case, it is sufficient to display a search screen by using the “search” button 60b or 60d shown in FIG. 13.

The second embodiment has been described with respect to the example in which data collected from a plurality of apparatuses for customer is managed by a single server and the process flow of the apparatus for pharmacist is finished by displaying the data received in step S71 onto the touch panel 21 in step S72 (refer to FIG. 21). The invention is not limited to the example. Also in the case where data collected from a plurality of apparatuses for customer is managed by a single server, the process flow of the apparatus for pharmacist may include steps corresponding to the steps S29 to S33 of the first embodiment after displaying the data received in step S71 onto the touch panel 21 in step S72. Concretely, health food containing a recommended component may be further retrieved or commodity information may be retrieved. In this case, it is sufficient to provide the controller of the server with commodity information DB corresponding to the commodity information DB 24f of the first embodiment.

What is claimed is:

1. A sales support system for supporting work of a salesperson of commodities, comprising:
input means for entering life information regarding life of a customer;
commodity selection support information generating means for generating commodity selection support information for supporting selection by the salesperson of a commodity for health of the customer on the basis of the life information entered by the input means; and
output means for outputting the commodity selection support information generated by the commodity selection support information generating means.

2. The sales support system according to claim 1, further comprising detecting means for detecting biological information of the customer,
wherein the commodity selection support information generating means generates the commodity selection support information on the basis of biological information detected by the detecting means and the life information entered by the input means.

3. The sales support system according to claim 1, further comprising maintenance/improvement information generating means for generating maintenance/improvement information for suggesting a method of maintaining or improving health of a customer on the basis of the life information entered by the input means,
wherein the output means outputs maintenance/improvement information generated by the maintenance/improvement information generating means.

4. The sales support system according to claim 1, wherein the commodity selection support information includes information of a component to be taken by the customer to maintain or improve his/her health.

5. The sales support system according to claim 1, wherein the commodity selection support information includes information of a commodity to be recommended to a customer by a salesperson.

6. The sales support system according to claim 1, further comprising advice information generating means for generating advice information used by a salesperson to give a piece of advice to a customer on a method of maintaining or improving health of the customer on the basis of the life information entered by the input means,
wherein the output means further outputs advice information generated by the advice information obtaining means.

7. The sales support system according to claim 1, wherein the commodity selection support information is information for supporting selection by a pharmacist of a commodity to be purchased by a customer in order to maintain or improve health of the customer.

8. The sales support system according to claim 1, further comprising:
a first device including the input means; and
a second device including the output means.

9. The sales support system according to claim 8, wherein the commodity selection support information generating means is included in the first device of the second device.

10. The sales support system according to claim 8, further comprising an information processor including the commodity selection support information generating means,
wherein the first device and the information processor can perform communication with each other, and the second device and the information processor can perform communication with each other.

11. The sales support system according to claim 10, wherein the information processor further comprises commodity selection support information storing means for storing a plurality of pieces of the commodity selection support information, and
the commodity selection support information generating means selects predetermined commodity selection support information from the plurality of pieces of commodity selection support information on the basis of life information entered by the input means.

12. The sales support system according to claim 10, wherein the first device further comprises transmitting means for transmitting identification information for identifying a customer to the information processor, and storing means for storing the identification information and the commodity selection support information so as to be associated with each other,
the second device further comprises second input means for entering the identification information, and
the output means outputs the commodity selection support information identified by the identification information entered by the second input means.

13. The sales support system according to claim 12, wherein the first device further comprises printing means for printing the identification information and, by entering the identification information printed by the printing means by the second input means, the output means outputs the commodity selection support information identified by the identification information.

14. The sales support system according to claim 13, wherein the identification information printed by the printing means is a bar code.

15. The sales support system according to claim 14, wherein the second input device is a bar code reader.

16. The sales support system according to claim 10, wherein the information processor comprises:
maintenance/improvement information generating means for generating maintenance/improvement information for suggesting a method of maintaining or improving health of a customer on the basis of the life information entered by the input means; and
transmitting means for transmitting the maintenance/improvement information to the first device,
the first device further comprises:
obtaining means for obtaining the maintenance/improvement information transmitted by the transmitting means; and
printing means for printing the maintenance/improvement information obtained by the obtaining means, and
the printing means prints the maintenance/improvement information.

17. The sales support system according to claim 16, wherein the first device further comprises second transmitting means for transmitting identification information for identifying a customer to the information processor,
the information processor further comprises storing means for storing the identification information and the maintenance/improvement information so as to be associated with each other, and
the printing means prints the maintenance/improvement information together with the identification information.

18. An information processor connected to a first device for entering life information regarding life of a customer and a second device for outputting commodity selection support information for supporting selection by a salesperson of commodities for health of a customer, comprising
commodity selection support information generating means for generating the commodity selection support information on the basis of the life information entered to the first device.

19. An adviser support system for supporting an adviser, comprising:
input means for entering life information regarding life of a person to whom a piece of advice is to be given;
commodity selection support information generating means for generating commodity selection support information for supporting selection by the adviser of a commodity for health of the person to whom a piece of advice is to be given on the basis of the life information entered by the input means; and
output means for outputting the commodity selection support information generated by the commodity selection support information generating means.

20. The adviser support system according to claim 19, further comprising a first device including the input means and a second device including the output means,
wherein the commodity selection support information generating means is included in the first device or the second device.
